(19) United States
(12) Patent Application Publication
(10) Pub. No.: US 2017/0002210 A1
(43) Pub. Date: Jan. 5, 2017

(54) Aqueous-Based Coating Composition Containing a Polyanhydride

(71) Applicant: PPG Industries Ohio, Inc., Cleveland, OH (US)

(72) Inventors: Robert McVay, Cincinnati, OH (US); Christopher Most, Wilder, KY (US)

(73) Assignee: PPG INDUSTRIES OHIO, INC., Cleveland, OH (US)

(21) Appl. No.: 14/934,573

(22) Filed: Nov. 6, 2015

Related U.S. Application Data
(63) Continuation-in-part of application No. 14/788,911, filed on Jul. 1, 2015.

(51) Int. Cl. C09D 5/08; B65D 1/12; B65D 25/14; C09D 133/08

(52) U.S. Cl. CPC C09D 5/08; C09D 133/08; B65D 1/12; B65D 25/14

(57) ABSTRACT

An aqueous-based coating composition suitable as a package coating comprising:
(a) a resinous phase comprising:
   (i) an at least partially neutralized acid functional polymer containing reactive functional groups,
   (ii) a curing agent containing functional groups that are reactive with the functional groups of (i),
   (iii) a polyanhydride having the following structural formula:

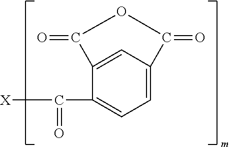

where m=2 to 4 and X is a divalent, trivalent or tetravalent organic group including mixed groups,
the resinous phase dispersed in
(b) aqueous medium.

### CROSS REFERENCE TO RELATED APPLICATION

This application is a continuation-in-part of copending application Ser. No. 14/788,911, filed Jul. 1, 2015.

### FIELD OF THE INVENTION

The present invention relates to aqueous-based coating compositions suitable as package coatings, particularly for the interior surface of cans exposed to corrosive acidic food stuffs.

### BACKGROUND OF THE INVENTION

Coatings are typically applied to the interior of metal food and beverage containers to prevent the contents from contacting the metal surface of the container. Contact with certain foods, particularly acidic products, can cause the metal container to corrode. This corrosion results in contamination and deterioration in the appearance and taste of the food or beverage product.

Corrosion problems are particularly acute with acidic food stuffs. Although coating compositions such as those based on polyglycidyl esters of bisphenol A can provide excellent corrosion protection for acidic food stuffs, coatings made with bisphenol A and derivatives thereof are problematic. These materials are perceived as being harmful to human health. Consequently there is a strong desire to eliminate these materials from coatings in contact with food stuffs.

Aqueous-based coatings based on (meth)acrylic polymers and phenolplast curing agents and modified with amine-terminated polyamides as disclosed in U.S. Pat. No. 7,475,786 have been proposed for use as interior coatings on metal cans for salty food stuffs such as soups containing high levels of KCl such as chicken noodle soup. However, the amine-terminated polyamide is prone to attack by acidic food stuffs such as tomatoes and soft drinks resulting in coating failure.

The present invention provides a composition that increases the acidity of the coating, which leads to better corrosion resistance to acidic food stuffs. Also, it is believed the composition provides a catalytic effect on curing permitting the use of less reactive and less costly curing agents.

### SUMMARY OF THE INVENTION

The present invention provides an aqueous-based coating composition suitable for coating the interior surface of a package in contact with food stuffs comprising:
(a) a resinous phase comprising
   (i) an at least partially neutralized acid functional polymer containing reactive functional groups,
   (ii) a curing agent containing functional groups that are reactive with the functional groups of (i), and
   (iii) a polyanhydride having the following structural formula:

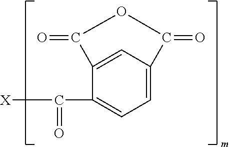

where m=2 to 4 and X is a divalent, trivalent or tetravalent organic group including mixed groups,
the resinous phase dispersed in
(b) aqueous medium.

The invention also provides a coated package having a food or beverage-contacting surface in which the above-described coating composition is applied to the food or beverage-contacting surface.

The invention also provides (a) providing a metal substrate with a food or beverage-contacting surface, (b) applying the coating composition mentioned above to the food or beverage-contacting surface, and (c) forming the substrate into a package before or after application of the coating composition.

### DETAILED DESCRIPTION

As indicated above, the compositions contain an at least partially neutralized acid functional polymer containing reactive functional groups (i). Examples of such functional groups are hydroxyl that are reactive with the phenolplast and aminoplast curing agents and N-alkoxymethylol groups that are also reactive with the phenolplast and aminoplast and with each other. The acid functional polymer can be a (meth)acrylic polymer.

Among the monomers used in preparing the (meth)acrylic polymer are ethylenically unsaturated carboxylic acids such as acrylic acid, methacrylic acid, itaconic acid, crotonic acid, and maleic acid.

The ethylenically unsaturated carboxylic acid is used in amounts of 20 to 35 percent, such as 22 to 33 percent by weight based on total weight of monomer used in preparing the (meth)acrylic polymer.

The monomer with the reactive functional group can be selected from hydroxyalkyl esters of (meth)acrylic acid, typically containing 2 to 4 carbon atoms in the hydroxyalkyl group and from N-alkoxymethylol groups derived from (meth)acrylamide containing from 1 to 4 carbon atoms in the N-alkoxy group.

Examples include hydroxyethyl (meth)acrylate and hydroxypropyl (meth)acrylate and monomers of the structure:

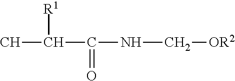

where R¹ is hydrogen or methyl and R² is lower alkyl containing from 1 to 4 carbons. Specific examples of such monomers are N-ethoxymethyl (meth)acrylamide and N-butoxymethyl (meth)acrylamide.

The monomers containing the reactive functional groups are typically present in amounts of 0.2 to 30, such as 5 to 40 percent by weight based on total weight of monomers used in preparing the (meth)acrylic polymer.

Other monomers are usually used in preparing the (meth)acrylic polymer. Examples include aromatic monomers such as styrene and vinyl toluene that are present in amounts of up to 10, such as 35 percent by weight based on total weight of monomers used in preparing the (meth)acrylic polymer; alkyl esters of (meth)acrylic acid containing from 1 to 8 carbon atoms in the alkyl group, such as methyl (meth)acrylates butyl (meth)acrylate and 2-ethylhexyl (meth)acrylate that are present in amounts up to 15, such as 45 percent by weight based on total weight of monomers used in preparing the (meth)acrylic polymer.

The (meth)acrylic polymer is formed by free radical polymerization in the presence of a free radical initiator. Examples of initiators are azo compounds, such as, for example, alpha, alpha′-azobis(isobutyronitrile). Other useful initiators are tertiary-butyl perbenzoate, tertiary-butyl pivalate, isopropyl percarbonate, benzoyl peroxide and cumene hydroperoxide.

The (meth)acrylic polymer typically has a number average molecular weight (Mn) of 2500 to 20,000, as determined by gel permeation chromatography using a polystyrene standard.

The partially neutralized acid functional polymer containing functional groups (i) is usually present in the composition in amounts of 20 to 50, such as 25 to 35 percent by weight based on weight of resin solids in the coating composition. Amounts less than 20 percent by weight do not provide stable dispersions, whereas amounts greater than 50 percent by weight result in blistering of the film upon baking.

Component (ii) is a curing agent or crosslinker containing functional groups that are reactive with the functional groups of (i).

Suitable curing agents are phenolplasts or phenol-formaldehyde resins and aminoplast or triazine-formaldehyde resins. The phenol-formaldehyde resins are preferably of the resol type. Examples of suitable phenols are phenol itself, butyl phenol, xylenol and cresol. Cresol-formaldehyde resins, typically etherified with butanol, are often used. For the chemistry in preparation of phenolic resins, reference is made to “The Chemistry and Application of Phenolic Resins or Phenolplasts”, Vol. V, Part I, edited by Dr. Oldring; John Wiley & Sons/Cita Technology Limited, London, 1997. Examples of commercially available phenolic resins are PHENODUR® PR285 and BR612 and those resins sold under the trademark BAKELITE®, typically BAKELITE 6581LB.

Examples of aminoplast resins are those which are formed by reacting a triazine such as melamine or benzoguanamine with formaldehyde. Preferably, these condensates are etherified typically with methanol, ethanol, butanol including mixtures thereof. For the chemistry preparation and use of aminoplast resins, see “The Chemistry and Applications of Amino Crosslinking Agents or Aminoplast”, Vol. V, Part II, page 21 ff., edited by Dr. Oldring; John Wiley & Sons/Cita Technology Limited, London, 1998. These resins are commercially available under the trademark MAPRENAL® such as MAPRENAL MF980 and under the trademark CYMEL® such as CYMEL 303 and CYMEL 1123, available from Allenex AB.

The amount of component (ii) is usually 15 to 60 percent by weight, such as 20 to 50 percent by weight. If the amount of component (ii) exceeds 60 percent by weight, the coating becomes brittle and will fracture when the end, lid, is seamed on the can. Amounts less than 15 percent by weight result in poor corrosion resistance.

The third component of the resinous phase is a polyanhydride hardener prepared from trimellitic anhydride having the following structure:

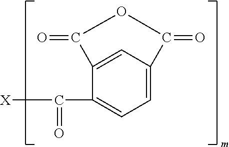

where m=2 to 4 and X is a divalent, trivalent or tetravalent organic group including mixed groups.

Typically, X is a group of the structure:

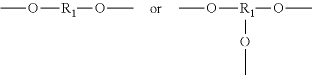

where R₁ is C₂ to C₆ alkylene such as ethylene, butylene, hexylene or C₂ to C₃ alkylidyne group such as ethylidyne and propylidyne. The polyanhydrides can be prepared by reacting trimellitic anhydride with a polyol such as ethylene glycol or glycerol including mixtures thereof. In the structure above, R₁ would be the residue of a polyol. The polyanhydrides are commercially available from Huntsman Corporation under the trademark ARADUR such as ARADUR 3380.

Component (iii) is typically present in the coating composition in amounts of 0.1 to 5, such as 0.5 to 3 percent by weight, based on weight of resin solids in the coating composition. Amounts less than 0.1 percent by weight do not provide for enhanced corrosion protection, whereas amounts greater than 5 percent by weight result in instability of the wet coating.

Besides (i), (ii) and (iii), other resinous ingredients such as amine functional polyamides can be included in the resinous phase, which enhance adhesion and corrosion resistance of the coating. The amine-terminated polyamides are described in U.S. Pat. No. 7,475,786. When present, the amine-terminated polyamides are present in amounts of up to 20 percent by weight based on weight of resin solids.

Another optional ingredient that is typically present in the coating composition is a catalyst to increase the rate of cure or crosslinking of the coating compositions. Generally acid catalyst may be used and is typically present in amounts of about 0.05 to 5 percent by weight. Examples of suitable catalyst are dodecyl benzene sulfonic acid, methane sulfonic acid, paratoluene sulfonic acid, dinonyl naphthalene disulfonic acid and phenyl phosphonic acid.

Another useful optional ingredient is a lubricant, for example, a wax which facilitates manufacture of metal closures by imparting lubricity to the sheets of the coated metal substrate. Preferred lubricants include, for example, carnauba wax and polyethylene-type lubricants. If used, the lubricant is preferably present in the coating compositions of at least 0.1 percent by weight based on weight of resin solids in the coating composition.

Surfactants can optionally be added to the coating composition to aid in flow and wetting of the substrate. Examples of suitable surfactants include, but are not limited to, nonyl phenol polyether and salts. If used, the surfactant is present in amounts of at least 0.01 percent and no greater than 10 percent based on weight of resin solids in the coating composition.

The compositions of the invention are in the form of an aqueous dispersion in which the resinous phase is dispersed in aqueous medium. The aqueous medium of the dispersion may consist entirely of water in some cases but, more commonly, will consist of a mixture of water and water-soluble or water-miscible organic solvents. Suitable organic solvents are the ether type alcohols, such as ethylene glycol monobutyl ether (butyl Cellosolve), ethylene glycol monoethyl ether (ethyl Cellosolve) and the like, and lower alkanols having 2 to 4 carbon atoms such as ethanol propanol, isopropanol, butanol, and the like. Minor proportions of hydrocarbon solvents such as xylene, toluene, and the like may also be present in the aqueous medium. The aqueous medium may contain from about 60 percent to about 100 percent by weight of water and from about 0 percent to about 40 percent by weight of organic solvent. The percentage by weight is based on total weight of the aqueous medium.

To disperse the resinous phase in the aqueous medium, the (meth)acrylic polymer is at least partially neutralized with a base such as an amine. Examples of amines include ammonia, monoethanolamine and diethanolamine. Typically, the amine will neutralize at least 25 percent, such as at least 50 percent of the acid equivalents in the (meth)acrylic polymer.

The other resinous ingredient can then be combined with the (meth)acrylic polymer salt and the mixture dispersed in the aqueous medium. The resin solids content of the aqueous dispersion is typically from 20 to 40, such as 25 to 30 percent by weight based on total weight of the aqueous dispersion.

The compositions used in the practice of the invention are substantially free, may be essentially free and may be completely free of bisphenol A and reaction products thereof, including bisphenol A (“BPA”) and bisphenol A diglycidyl ether (“BADGE”). Such compositions are sometimes referred to as “BPA non intent” because BPA, including derivatives or residues thereof, are not intentionally added but may be present in trace amounts because of unavoidable contamination from the environment. The compositions can also be substantially free and may be essentially free and may be completely free of bisphenol F and derivatives or residues thereof, including bisphenol F and bisphenol F diglycidyl ether (“BPFG”). The term “substantially free” as used in this context means the compositions contain less than 1000 parts per million (ppm), “essentially free” means less than 100 ppm and “completely free” means less than 20 parts per billion (ppb) of any of the above-mentioned compounds, derivatives or residues thereof.

The coating compositions of the present invention can be applied to packages of all sorts and are particularly well adapted for use on food and beverage containers (e.g., two-piece cans, three-piece cans, etc.).

The compositions can be applied to at least a portion of the food or beverage-contacting surface of the package by any means known in the art such as roll coating, spraying and electrocoating. It will be appreciated that for two-piece food cans, the coating will typically be sprayed after the can is made. For three-piece food cans, a flat metal sheet or a coil metal strip will typically be roll coated with the coating composition and then the can body and/or the can end will be formed. As noted above, the percent solids of the composition can be adjusted based upon the means of application. The coating can be applied to a dry film weight of 24 mgs/4 in² to 12 mgs/4 in², such as 20 mgs/4 in² to 14 mgs/4 in².

After application, the coating is then cured. Cure is effected by methods standard in the art. For coil coating, this is typically a short dwell time (i.e., 9 seconds to 2 minutes) at high heat (i.e., 485° F. (252° C.) peak metal temperature); coated metal sheets typically cure longer (i.e., 10 minutes) but at lower temperatures (i.e., 400° F. (204° C.) peak metal temperature). For spray applied coatings on two-piece cans, the cure can be from 5 to 8 minutes, with a 90-second bake at a peak metal temperature of 415° F. (213° C.) to 425° F. (218° C.).

Any substrate material used for the formation of food or beverage containers can be treated according to the present methods. Particularly suitable substrates include aluminum, tin-plated steel, tin-free steel and black-plated steel.

### EXAMPLES

The following examples are offered to aid in understanding of the present invention and are not to be construed as limiting the scope thereof. Unless otherwise indicated, all parts and percentages are by weight. Examples A and B are of acid functional (meth)acrylic polymers containing reactive functional groups (OH and COOH). Example 1 is a control showing the formulation of an aqueous coating composition with the (meth)acrylic polymers of Examples A and B and phenolplast curing agents. Example 2 is that of the invention, which is similar to Example 1 but which contains the polyanhydride hardener of the invention. The coating compositions were applied to can interiors and cured and evaluated for corrosion resistance.

### Example A

A (meth)acrylic polymer was prepared by free radical polymerization in 2-butoxyethanol from the following monomer mixture: 25 percent by weight methacrylic acid, 25 percent by weight styrene, 45 percent by weight butyl acrylate and 5 percent by weight N-butoxymethylol acrylamide; the percentages by weight being based on total weight of monomers. The resulting polymer had an Mn of 3495 and a theoretical solids content of 52 percent by weight in 2-butoxyethanol.

### Example B

An aqueous dispersion of a (meth)acrylic polymer was prepared by first preparing a (meth)acrylic polymer by free radical polymerization in n-butanol from the following monomer mixture: 32 percent by weight methacrylic acid, 22.5 percent by weight styrene, 43 percent by weight butyl acrylate and 2.5 percent by weight N-butoxymethylol acrylamide; the percentages by weight being based on total weight of monomers. The resulting polymer had an Mn of 10,600 and a theoretical solids content of 52 percent by weight in butanol. The polymer was partially neutralized (30 percent of the total theoretical neutralization) with dimethylethanolamine and dispersed in water at a theoretical solids content of 43.5 percent by weight.

An aqueous coating composition was obtained by mixing together the following ingredients using a cowles dispenser heating to obtain a stable dispersion.

| Ingredient | Parts by Weight |
|---|---|
| Acrylic polymer of Example A | 250 |
| Phenolic resin 1¹ | 566 |
| Polyamide² | 32.5 |
| Acrylic polymer dispersion of Example B | 560 |
| Phenolic resin 2³ | 576 |
| Caprylic acid | 20 |
| Deionized water | 1500 |

¹Cresol-formaldehyde resin from Allenex as PR516.
²Amine-terminated polyamide from Momentive as EPIKURE 3115 (80% solids in butanol).
³Cresol-formaldehyde resin from Durez as 29-112.

### Example 2

An aqueous coating composition was obtained by mixing together the following ingredients and heating to obtain a stable dispersion.

| Ingredient | Parts by Weight |
|---|---|
| Acrylic polymer of Example A | 208 |
| Cresol-formaldehyde phenolic resin 1 of Example 1 | 566 |
| Polyamide of Example 1 | 32.5 |
| Polyanhydride hardener¹ | 68 |
| Acrylic polymer dispersion of Example B | 555 |
| Cresol-formaldehyde phenolic resin 2 of Example 1 | 576 |
| Caprylic acid | 20 |
| Deionized water | 1500 |

¹ARADUR 3380-1.

The coating compositions of Examples 1-2 were spray applied to the interior surface of 211×400 electro tin plated steel 2-piece D&l cans at a film weight of 285 mg±10 mg. The coatings were cured at 425° F. (218° C.) for 5 minutes. Cans were filled with diced tomatoes and steam processed for 30 minutes at 250° F. (121° C.) and stored at 120° F. (49° C.) for six weeks. The cans were removed from storage, cooled and cut open with four vertical cuts from the top to bottom and flattened to resemble a cross and the interior coated surfaces of the can evaluated for corrision protection, that were measured on a sale of 0 to 10. A reading of “0” indicates the coating is completely corroded, observed by bubbling or blistering of the film in all areas. A “10” indicates no evidence of corrosion. Evidence of corrosion was evaluated in the head space area that is the most difficult part of the 2-piece can to get corrision resistance because it contains the least amount of tin plating due to the drawing process.

The results of the testing on three cans are reported in the Table below.

TABLE
Corrosion Testing Results

| Coating Example | Corrosion |
|---|---|
| 1 | 6 |
| 1 | 5 |
| 1 | 6 |
| 2 | 9 |
| 2 | 8.5 |
| 2 | 9 |

As used herein, the following terms have the following meanings.

The term “organic group” means a hydrocarbon group (with optional elements other than carbon and hydrogen, such as oxygen, nitrogen, sulfur, and silicon).

The term “alkylene” or “alkylene group” refers to a straight or branched chain saturated divalent aliphatic group that may be substituted with hetero atoms such as nitrogen, oxygen and sulfur atoms.

The term “alkylidyne” or “alkylidyne group” refers to a straight or branched chain saturated trivalent aliphatic group that may be substituted with hetero atoms such as nitrogen, oxygen and sulfur atoms.

The term “package” means anything used to contain another item, particulary for shipping from a point of manufacture to a consumer, and for subsequent storage by a consumer. A package will be therefore understood as something that is sealed so as to keep its contents free from deterioration until opened by a consumer. The manufacturer will often identify the length of time during which the food or beverage will be free from spoilage, which typically ranges from several months to years. Thus, the present “package” is distinguished from a storage container or bakeware in which a consumer might make and/or store food; such a container would only maintain the freshness or integrity of the food item for a relatively short period. A package according to the present invention can be made of metal or non-metal, for example, plastic or laminate, and be in any form. An example of a suitable package is a laminate tube. Another example of a suitable package is a metal can. The term “metal can” includes any type of metal can, container or any type of receptacle or portion thereof that is sealed by the food/beverage manufacturer to minimize or eliminate spoilage of the contents until such package is opened by the consumer. One example of a metal can is a food can; the term “food can(s)” is used herein to refer to cans, containers or any type of receptacle or portion thereof used to hold any type of food and/or beverage. The term “metal can(s)” specifically includes food cans and also specifically includes “can ends” including “E-Z open ends”, which are typically stamped from can end stock and used in conjunction with the packaging of food and beverages. The term “metal cans” also specifically includes metal caps and/or closures such as bottle caps, screw top caps and lids of any size, lug caps, and the like. The metal cans can be used to hold other items as well, including, but not limited to, personal care products, bug spray, spray paint, and any other compound suitable for packaging in an aerosol can. The cans can include “two piece cans” and “three-piece cans” as well as drawn and ironed one-piece cans; such one piece cans often find application with aerosol products. Packages coated according to the present invention can also include plastic bottles, plastic tubes, laminates and flexible packaging, such as those made from PE, PP, PET and the like. Such packaging could hold, for example, food, toothpaste, personal care products and the like.

The term “food-contacting surface” refers to the surface of a package such as an inner surface of a food or beverage container that is in contact with, or intended for contact with, a food or beverage product. By way of example, an interior surface of a metal substrate of a food or beverage container, or a portion thereof such as a can end or a can body, is a food-contacting surface even if the interior metal surface is coated with a coating composition.

The term “on”, when used in the context of a coating applied on a surface or substrate, includes both coatings applied directly or indirectly to the surface or substrate. Thus, for example, a coating applied to a primer layer overlying a substrate constitutes a coating applied on the substrate.

Unless otherwise indicated, the term “polymer” includes both homopolymers and copolymers (e.g., polymers of two or more different monomers) and oligomers.

Acrylic and methacrylic monomers and polymers are designated as (meth)acrylic monomers and polymers.

As used herein, “a”, “an”, “the”, “at least one” and “one or more” are used interchangeably. Thus, for example, a coating composition that comprises “a” polyether can be interpreted to mean that the coating composition includes “one or more” polyethers.

Also herein, the recitations of numerical ranges by endpoints include all numbers subsumed within that range (e.g., 1 to 5 includes 1, 1.5, 2, 2.75, 3, 3.80, 4, 5, etc.). Furthermore, disclosure of a range includes disclosure of all subranges included within the broader range (e.g., 1 to 5 discloses 1 to 4, 4.5 to 4.5, 4 to 5, etc.).

Whereas particular embodiments of this invention have been described above for purposes of illustration, it will be evident to those skilled in the art that numerous variations of the details of the present invention may be made without departing from the invention as defined in the appended claims.

Although various embodiments of the invention have been described in terms of “comprising”, embodiments consisting essentially of or consisting of are also within the scope of the present invention.

1. An aqueous-based coating composition being substantially free of bisphenol A and reaction products thereof, comprising:
(a) a resinous phase comprising:
(i) an at least partially neutralized acid functional polymer containing reactive functional groups,
(ii) a curing agent containing functional groups that are reactive with the functional groups of (i),
(iii) a polyanhydride having the following structural formula: 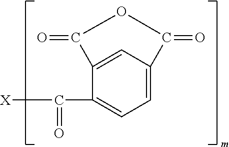
where m=2 to 4 and X is a divalent, trivalent or tetravalent organic group including mixed groups,
the resinous phase dispersed in
(b) aqueous medium.

2. The coating composition of claim 1 in which the acid functional polymer is a (meth)acrylic polymer.

3. The coating composition of claim 1 in which the reactive functional groups are carboxylic acid and/or hydroxyl.

4. The coating composition of claim 1 in which the curing agent is a phenolplast and/or an aminoplast.

5. The coating composition of claim 1 in which X is a group of the structure: 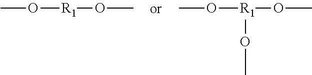
where R₁ is C₂ to C₆ alkylene or C₂ to C₃ alkylidyne.

6. The coating composition of claim 5 in which R₁ is a mixed organic group comprising C₂ to C₆ alkylene and C₂ to C₃ alkylidyne.

7. The coating composition of claim 1 in which (i) is present in the coating composition in amounts of 20 to 50 percent by weight based on weight of resin solids in the coating composition.

8. The coating composition of claim 1 in which (ii) is present in the coating composition in amounts of 20 to 50 percent by weight based on weight of resin solids in the coating composition.

9. The coating composition of claim 1 in which (iii) is present in the coating composition in amounts of 0.5 to 3 percent by weight based on weight of resin solids in the coating composition.

10. The coating composition of claim 1 which has a resin solids content of 25 to 30 percent by weight based on total weight of the composition.

11. A coated package or portion thereof having a food or beverage-contacting surface comprising a coating composition of claim 1 applied to at least a portion of the food or beverage-contacting surface of the package.

12. The coated package of claim 11 in which the package is an aluminum or steel container.

13. The coated package of claim 12 in which the container is a 2-piece or 3-piece can including a can end.

14. A method comprising:
(a) providing a substrate with a food or beverage-contacting surface,
(b) applying a coating composition of claim 1 to the food or beverage-contacting surface, and
(c) forming the substrate into a package before or after application of the coating composition.

15. The method of claim 14 in which the substrate is a metal sheet or a coil metal strip, each of which are subsequently formed into a can or a can end.

16. The method of claim 15 in which the can is a 2-piece can.
